(19) United States
(12) Patent Application Publication
(10) Pub. No.: US 2009/0188346 A1
(43) Pub. Date: Jul. 30, 2009

(54) Reciprocating impulse drive

(76) Inventor: Steven Michael Hampton, London Mills, IL (US)

Correspondence Address: Steven M. Hampton, 33161 N. County Hwy 16, London Mills, IL, 61544-9357, US

(21) Appl. No.: 12/011,755

(22) Filed: Jan. 29, 2008

(51) Int. Cl. F03G 3/00; F16H 33/20

(52) U.S. Cl. 74/84 S; 74/84 R

(57) ABSTRACT

Electric reciprocating impulse engine converts rotary motion into linear motion at a frequency high enough to overcome inertia and propel said engine with load. The present invention loses substantial weight while running without losing mass and could drive a satellite already in orbit or beyond and propel a spacecraft between the planets with five-times the efficiency of conventional propulsion systems. Each of the two carriages below the control platform of the apparatus hold a pair of elongated eccentric rotors that counter-rotate forcing said carriages to bounce up and down on rigid spring-loaded rods at a precise distance with equal force in opposite directions on the common mainframe. The two carriages can be phased 180 degrees apart with thrust determined by the rotor's mass and velocity, the latter which can be finely controlled by varying the voltage to the rotor drive motors. Unlike prior art, when this apparatus's shifters are engaged the increased axial displacement and combined frequency of the two carriages in oscillation generate rapid impulses within the mainframe to overcome its inertia and smoothly impel said apparatus vertically away from gravity or along a linear path in free space.

### BACKGROUND OF THE INVENTION

1. Field of the Invention

This invention relates to self-contained apparatus for converting rotary motion into linear motion, and more particularly to devices utilizing unbalanced centrifugal forces in such a manner to result in moving the device along a linear, and particularly vertical, path.

2. Description of the Prior Art

Numerous attempts have been made to propel a drive apparatus and attached vehicle along a linear path with the apparatus using unbalanced centrifugal forces generated by gyratory action within the apparatus. However, the known devices are incapable of exerting a uniform and significant linear force to be useful as a drive apparatus. The interrelationship of their component parts produce forces which tend to cancel out each other with little or no resultant linear force being exerted. Also, the prior art devices often are complicated and have excessive internal friction which further reduces their efficiency. The prior art also is not deigned to minutely flex perpendicular to stresses while under variable loads. They also do not have a substantial axial displacement which is tantamount to producing thrust in rotary to linear systems. Neither can such prior art with the greater axial displacement cycle at a rate high enough to overcome the apparatus's own inertia and propel with a meaningful load in a linear path.

Typical of the prior art approaches to the conversion of rotary motion into linear motion are the following patents:

| U.S. Pat. No. | Date of Issue | Inventor | Cross-Reference |
|---|---|---|---|
| 2,886,976 | May 19, 1959 | Dean | 74/61 |
| 3,182,517 | May 11, 1965 | Dean | 74/61 |
| 3,238,714 | Mar. 8, 1966 | G. O. Schur | 60/35.5 |
| 3,653,269 | Apr. 4, 1972 | Foster | 74/84 |
| 3,979,961 | Sep. 14, 1976 | Schnur | 74/61 |
| 4,050,317 | Sep. 27, 1977 | Brandt | 74/64 |
| 4,238,968 | Dec. 16, 1980 | Cook | 74/84R |
| 4,744,259 | May 17, 1988 | Peterson | 74/84S |
| 4,770,063 | Sep. 13, 1988 | Mundo | 74/84S |
| 5,024,112 | Jun. 18, 1991 | Kidd | 74/84S |
| 5,090,260 | Feb. 25, 1992 | Delroy | 74/84S |
| 5,156,058 | Oct. 20, 1992 | Bristow, Jr. | 74/84R |

The above listed patents are believed to be relevant to the present invention because they were adduced by a prior art search made by an independent searcher.

Typical of the published references cited are the following:

John W. Campbell, Jr., “The Space Drive Problem”, Astonishing Science Fact and Fiction, June 1960, pp. 83-106.

Richard F. Dempewolff, “Engine with Built-in Wings” Popular Mechanics, September 1961, pp. 131-134, 264-266.

William O. Davis, “The Fourth Law of Motion”, Analog, May, 1962, pp. 85-104.

Norman L. Dean, “Brass Tacks: Eccentric Rotor Phasing”, Analog, May 1963, pp. 5-6, 89-90.

G. Harry Stine, “Detesters, Phasers and Dean Drives”, Analog, June, 1976, pp. 60-80.

### SUMMARY OF THE INVENTION

The method of converting rotary motion into linear motion of the present invention involves orbiting a set of two eccentrics in opposite directions on a plane where their masses add on two sides every cycle to produce a bidirectional impulse on said plane of oscillation. Another set of counter-rotating eccentrics are arranged along the same oscillatory plane of the previous set of eccentrics but set 180 degrees out of phase with the first. Any number of such sets of eccentrics can be used along the plane of oscillation. A means is also provided to shift, clutch, and release the axis of the eccentrics at a precise time in their cycle to smoothly impel the apparatus in the desired direction.

The linear force from this reciprocating impulse drive may be used to propel any object attached to the mainframe of the present invention without requiring loss of mass into the surrounding environment.

The self-contained linear drive of the present invention, however, requires only the amount of energy necessary to spin the mass units and to shift their axis with none of the energy being expended or wasted by ejecting mass from the linear space drive.

The rotary to linear drive of the present invention is useful for propelling other vehicles such as automobiles and boats. Such a watercraft would need only hull contact with the water which can be streamlined to the most efficient shape for traveling on the surface or below the water. Because the direction of force can be changed within the vehicle, no rudders or other external apparatus is required.

In the case of land vehicles, the linear drive means of the present invention can both support and propel the vehicle. Because of this, wheels, tires, roadways and bridges are not required and consequently the enormous amounts of money presently being spent to counteract the wear and tear of vehicle contact with rails or roadways can be eliminated.

In the case of aircraft, the wings or rotors which support the aircraft in the air can be eliminated with the space drive of the present invention both supporting and propelling a fully streamlined aircraft through the air. The described uses of the present invention are only illustrative and many other uses and advantages of the present invention can be found.

The preferred invention converts rotary motion into linear motion at a frequency high enough to overcome the apparatus's inertia and propel said apparatus with a load. The present invention loses substantial weight while running without losing mass and could drive a satellite already in orbit or beyond and propel a spacecraft between the planets with five-times the efficiency of conventional propulsion systems. The system may also be employed as an impact wrench, recoilless jackhammer, forklift, windlass, winch, sky-hook, spatial anchor, space-suit maneuvering and numerous other tasks.

Each of the two carriages below the control platform of the apparatus hold a pair of rod-shaped eccentric rotors that counter-rotate forcing said carriages to bounce up and down on rigid spring-loaded rods at a precise distance with equal force in opposite directions on a common mainframe. The two carriages are phased 180 degrees apart with thrust determined by the rotor's mass and velocity, the latter which can be finely controlled by varying the voltage to the rotor's drive motors. Unlike prior art, when the apparatus's shifters are engaged, the increased axial displacement and the combined frequency of the two carriages in oscillation generate rapid impulses within the mainframe to smoothly impel said apparatus vertically away from gravity.

The apparatus for converting rotary motion into linear motion provides a series of carriage trays each framing a set of eccentrics and clutches. These trays must be constructed of lightweight materials and the eccentrics should be as heavy as practical. In the present invention the two carriage trays oscillate 0 degrees in phase with each other at initial start-up to overcome the inertia of the load, then 180 degrees out of phase for continual thrust. Also at a precise time in the eccentric rotor's cycle the rack and pinion shifters and the clutches are activated and the opposing oscillating carriages impulse in turn upon the mainframe in an upward direction at twice the rate of a single carriage alone. Thus the resultant frequency of impulses is doubled that of a single set of eccentrics. In essence each carriage is in turn shifted upward before the eccentric rotors can drive them there which advances said carriages to or beyond the upper end of their normal oscillatory motion. This effectively increases the eccentric's time in the positive half of the cycle. Upon completing the forward end of their cycle in positive phase centrifugal acceleration from the momentum of the eccentrics propels the carriages and mainframe upward against gravity causing the whole apparatus to lose substantial weight without losing mass.

The mainframe of the present invention with the support rod and platform configuration has the advantage of slight perpendicular flexing when the apparatus is under certain loads. This prevents breakage of parts that might otherwise resist intermittent load variations without the mainframe going into unwanted resonance.

The present invention requires minimal lubrication by use of sealed motor bearings, thermoplastic bushings and journals, and Delrin, Phenol, or other such lightweight and low-friction gears.

In the present invention the eccentrics are precessed at the proper moment to include additional time in the positive half of the cycle to impart centrifugal acceleration into the structure in an upward direction without loss of rotor momentum. Momentum is conserved because the combined effects of the rotor cycle within its carriage cycle creates two inertial frames that when shifted, causes the rotors to gain time within their isolated carriage cycle. This creates a pulsed phenomenon upon the main inertial frame, or mainframe, generated from the two inertial frames of the rotor and the carriage complex resulting in cyclic demands upon the power supply—thus also fulfilling the law of Conservation of Energy. Newton's third law of motion is upheld because action and reaction are not simultaneous events, and in this apparatus, the inertial delay time between action and reaction is extended beyond that of typical rotary to linear mechanical systems or conventional propulsion systems. The present invention represents a dual asymmetrical oscillator complex with four separate inertial frames in motion every mainframe cycle.

In the preferred form of the invention, each carriage oscillates at 4 cps or higher with a resultant impulse frequency of 8 cps or higher upon the mainframe. According to independent researchers such a flight system must impulse or cycle at the rate of 7.6 cps or higher to overcome gravity. As such, the present invention constitutes a full-wave rectified mechanical oscillator whereby gravity may be lessened or neutralized when each carriage achieves 3.8 cps or higher, thus supplying 7.6 cps or higher impulses to the overall apparatus.

The present invention is energy efficient because the rotary motion of the eccentrics is mechanically converted into a bidirectional oscillation of the eccentric's axis in the carriage tray assembly. When the shifters are actuated in the upward direction at the proper time in the cycle the direction and momentum of the eccentrics have low inertia and present little resistance to the shifters and the carriage tray is essentially rectified from a sinusoidal motion to an unbalanced impulse: The 360 degree rotary motion of the rotors is converted into a powerful 180 degree bilateral motion of the carriage and then precessed to release impulses for thrust. These separate inertial frames allow the present invention to be approximately five times more efficient than conventional propulsion systems.

It should be noted that for a precise and sustained oscillation upon the mainframe, the carriages can be synchronized 180 degrees apart by using one or more of the following devices; one, encoder or stepping motors or other servo devices that have the required torque to drive the rod-rotors or; two, a spring-loaded timing belt between the two or more carriages or; three, slider- or motion-type contact switches in electrical series with the shifters that are mounted on the mainframe and carriages to allow power to the shifters only when the carriages are 180 degrees apart; fourth a variably synchronized electronic circuit may be employed to at first overcome load inertia then changes its electrical condition to allow for smooth and continuous thrust.

It is therefore a principle object of the present invention to provide a method and apparatus for converting rotary motion into linear motion in a self-contained unit.

Another object of the present invention is to provide a method and apparatus of the character described in which the orbits of the side-by-side flying mass units are constrained in such a manner that the centers of orbit shift up and down, or back and forth, and then can be axially advanced every cycle to produce a substantially straight line linear force extending in the desired direction.

A further object of the present invention is to provide an apparatus for converting rotary motion into linear motion in a self-contained unit capable of propelling an attached vehicle in a desired straight line direction which can be varied from time to time as desired.

A still further object of the present invention is to provide an apparatus of the character described which is compact and sturdy with a minimum of moving parts subject to friction and wear.

Another object of the present invention is to provide an apparatus of the character described which is relatively inexpensive and requires a minimum of machining.

Other objects and features of advantage will become apparent as the specification progresses, and from the claims.

### BRIEF DESCRIPTION OF THE DRAWINGS

The invention is illustrated diagrammatically in the accompanying drawings by way of example. The diagrams illustrate only the principle of the invention and one mode of applying said principle. It is however to be understood that the purely diagrammatic showing does not offer a survey of possible constructions and a departure from the constructional features diagrammatically illustrated does not necessarily imply a departure from the principle of the invention.

In the drawings:

FIG. 1 is an overview diagram illustrating the proportional placing of the oscillator carriages in relation to the control platform and depicting nearly all the major parts comprising the invention.

FIG. 2 is a partial cut-a-away view of the torque-increasing gear train for the rotor drive side of the carriage tray, looking from the inside the carriage tray.

FIG. 3 is a top view of the carriage tray assembly.

FIG. 4 is a view of the control end of the carriage tray housing the acceleration detector in the center with the optical cams, pick-up sensors and their associated electronics. The carriage tray in FIG. 3 with its front and back channel members holding the majority of parts depicted in FIG. 2 and FIG. 4 are shown orientated with the top edge of the said channel members coming out of the page towards the viewer to comprise the end segments of the carriage tray.

FIG. 5 depicts the rack and pinion shifter assembly with its torque-increasing gear train and drive motor.

FIG. 6 depicts a partial cut-a-way side view of clutch assembly comprising a push-type solenoid with adaptive plunger and friction pad interfacing with a mainframe support rod, channel bushing and quick-release back-EMF blocking diode with terminal strip mounted on a carriage tray channel member.

FIG. 7 displays the control platform assembly showing the electrical component side with their placement arranged to balance the weight of the platform. These topside components include the DC-to-DC converter to power the sensors; the solid state relay board; terminal blocks and strips; LED indicators; control switches; cooling fans if needed; power jacks; the shifter rack journal bushing assemblies; and back-EMF blocking diodes with their terminal strips for the shifter motors. The other side, in this case the bottom side, holds the shifter assemblies with associated linear drive motors as shown in FIG. 5.

FIG. 8 illustrates a stylized control panel template with parts orientation and a backside view of said control panel and its electrical wiring in block schematic form.

FIG. 9 depicts the solid state relay (SSR) board designed for the present invention. The printed circuit board (PCB) has conductive tracing on both sides with through-plated holes and holds the SSRs with their associated components and controls the shifters and clutches with signals from the cam sensors.

FIG. 10 depicts the overall system flow chart powered by a dual fixed and variable power supply.

FIG. 11 illustrates the shifter schematic for top and bottom carriages.

FIG. 12 illustrates the clutch schematic for top and bottom carriages.

While only the preferred form of the invention is illustrated in the drawings, it will be apparent that various modifications could be made without departing from the ambit of the claims.

### DESCRIPTION OF THE PREFERRED EMBODIMENTS

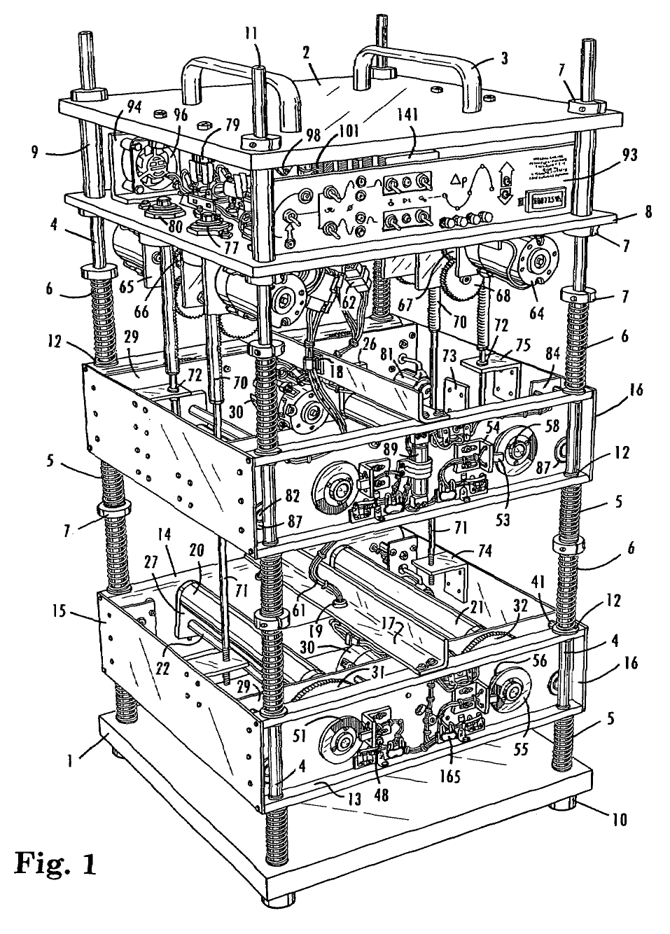

In FIG. 1, the mainframe assembly comprises of a base plate 1 joined to a top cover plate 2 with mounted handles 3 by a plurality of mainframe support rods 4. Each mainframe support rod is surrounded by two pairs of two different sets of compression springs: one pair for each oscillator on each support rod. The bottom set of springs 5 for each oscillator has a spring-rate that will freely suspend the oscillator assembly. The top set of springs 6 has a lower spring-rate but longer free-length to allow an upward shift of the oscillator assembly when the apparatus is used as a means to overcome gravity. These spring sets are stacked on the mainframe support rods 4 and set at a fixed distance between the base and top plate with shaft collars or rod clamps 7.

The suspension system for the oscillators comprise the above mentioned two different sets of compression springs with unequal spring rates: If the system is used against a gravitational field as shown here in FIG. 1, the bottom set of compression springs 5 should be a stiffer spring-rate than the top set 6. In a horizontal position or outside a gravitational field, the top and bottom springs should be of equal spring-rates and evenly spaced. The shifter distance between the top of the rack 62 and the positive stop 71 in FIG. 6 must also be increased by the same distance as the difference made by the longer bottom compression springs.

The top cover plate 2 holds the other ends of the mainframe support rods 4 together at a fixed distance from the shaft collar 7 containing the oscillators by means of another set of shaft collar 7. Said rod clamps keep the control platform 8 at a fixed distance for radial gain from the oscillators. Spacers 9 also keep the top cover plate and the control platform at a fixed distance determined by the overall radial gain of the system and the height limitations of the control display panel 93. On the bottom end of the mainframe rods are mounted shock absorbing pads 10. At the top end of the mainframe rods are threaded holes 11 for mounting the engine or to hold eyebolts so the engine can be tethered for weight loss experiments and adjustments, or loaded into a satellite or spacecraft.

Also in FIG. 1 the oscillators, also termed the carriage tray assemblies, are suspended on the compression spring-loaded mainframe support rods 4. Referring primarily to the bottom carriage tray, each carriage tray journals through thermoplastic or other light bushings 12 mounted in extruded Fiberglass channel or other lightweight channel members 13 and 14 which are attached to side plates 15 and 16 forming a frame or tray. A supportive cross member 17 braces the tray assembly and also serves as a handle when the carriage is not mounted within the mainframe of the apparatus. The cross member 17 on the top carriage tray holds a low-friction sleeve 18 for the umbilical cable that feeds the bottom carriage tray. The top and bottom umbilical are made up of a bundle of insulated stranded wires whose insulation is of low-friction, such as Teflon. For the bottom carriage, said umbilical loosely journals through a low-friction sleeve 18 mounted on the top carriage tray support member 17 that can be opened to allow removal of the umbilical from said top carriage tray when dissembled for repair or transport. The lower end of said umbilical is secured by a cable strain-relief grommet 19 mounted on the bottom carriage tray's cross member 17.

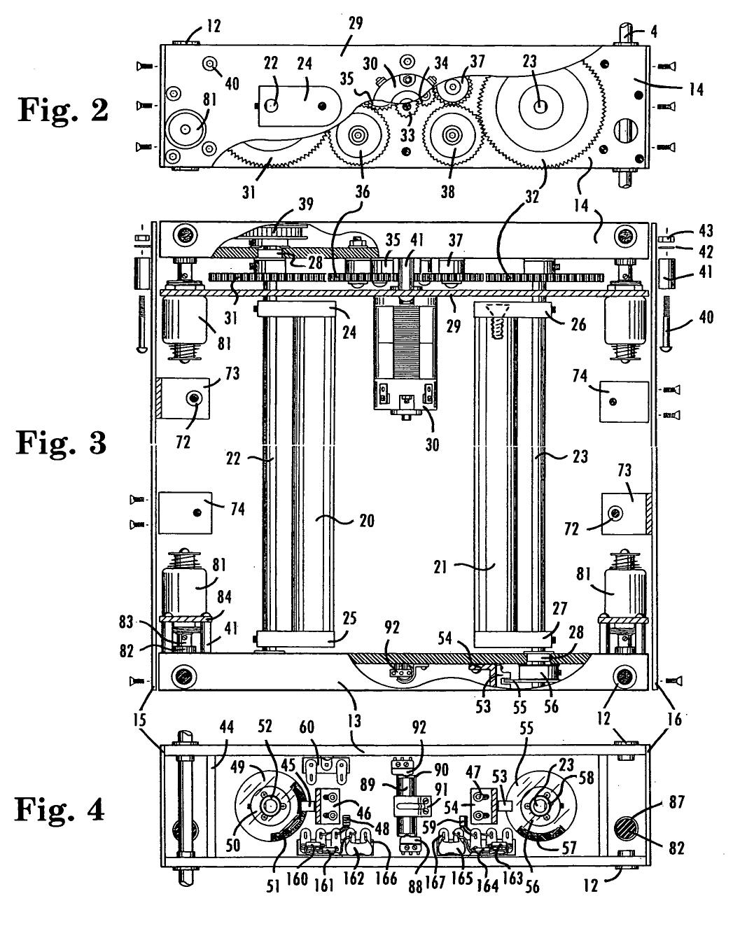

In FIG. 3, each carriage tray assembly houses rod-rotors 20 and 21 along with their drive trains. These rod-rotors can be made of brass, bronze, tungsten, depleted uranium or other heavy material and are mounted to their axles 22 and 23 by armatures 24, 25 and 26, 27. Overall carriage tray size is determined primarily on the density of the rod-rotors. Said rod-rotors can be dimpled or otherwise textured for reduced air resistance to increase speed and efficiency. The rod-rotor axles 22 and 23 journals through the channel members 13 and 14 via thermoplastic or other light bushings 28 shown in partial cut-a-way view of item 14 in FIG. 3 and also journals through rotor drive motor mounting plate 29. This plate also acts as a heat sink for rod-rotor drive motor 30. The carriages' up and down oscillation naturally fans and cools plate 29 thus cooling the motor 30. One end of axle 22 is mounted through the hub of drive gear 31. This drive gear is powered indirectly by motor 30 through the torque splitting assembly shown in FIG. 2. Likewise, rod-rotor axle 23 journals through the channel members 13 and 14 via bushings 28 and also journals through rotor drive motor mounting plate 29. On one end of axle 23 is mounted the hub of drive gear 32. This drive gear is also powered indirectly by motor 30 through the torque splitting assembly shown in FIG. 2.

Referring to FIG. 2, the shaft of rod-rotor drive motor 30 holds pinion 33 that splits torque with reversing pinion 34 of equal diameter. Pinion 33 also drives speed-reducing gear 35 that drives another reducer gear 36 that powers the drive gear 31 which supplies rotary torque to the left rod-rotor 20. For the right rod-rotor 21, the torque splitting reversing pinion 34 supplies rotation to speed-reducing gear 37 which in turn drives another speed-reducing gear 38 supplying torque to drive gear 32. Optional timing pulley 39 can mount on one end of rod-rotor axle 22 or 23.

Drive motor mount plate 29 in FIG. 3, is mounted to channel member 13 with fasteners 40, spacers 41, and fastened through the other side of the channel member 13 by threads in said member and secured with lock washer 42 and locking nut 43. This plate also creates an enclosure for the rotor drive gear assembly.

Referring to FIG. 4, should the apparatus be employed horizontally within a gravitational field requiring the use of clutches, an isolation bulkhead 44 mounted on the inside of channel member 13 prevents minute clutch pad debris from entering the area of the optical sensor cam assembly mounted on the rotor axle shafts 22 and 23. Working vertically against gravity or in free space the clutches are not necessary and 44 would not be needed. The optical pick-up sensor 45 for the shifter motors is fastened on an adjustable angle mount 46, fastened to channel member 13 with screws 47. A cam disk interfaces with pick-up sensor 45 and when it detects a blockage or admittance of light from the optical cam, sends an electrical signal to the preamplifier subassembly comprising primarily of transistor 48 with associated circuitry. This current path can also be extended with an inverter circuit to reverse the optical cam interfacing. In the present invention, the cam is a clear disk 49 mounted to rotor axle 22 by its hub 50. A clear film 51 with a cam or arc, painted or printed on its surface, is held on to the axle with a holding sleeve 52. A thin mechanical cam can also be employed to interface with pick-up sensor 45. The clutch assembly is controlled by an identical pick-up sensor assembly 53, 54, 55, 56, 57 and 58 on the right-hand side of the carriage tray on axle 23. It supplies a signal for preamplifier transistor 59 and its associated circuitry. Terminal strip 60 joins electrical wiring for the clutch solenoids and is also a service test point.

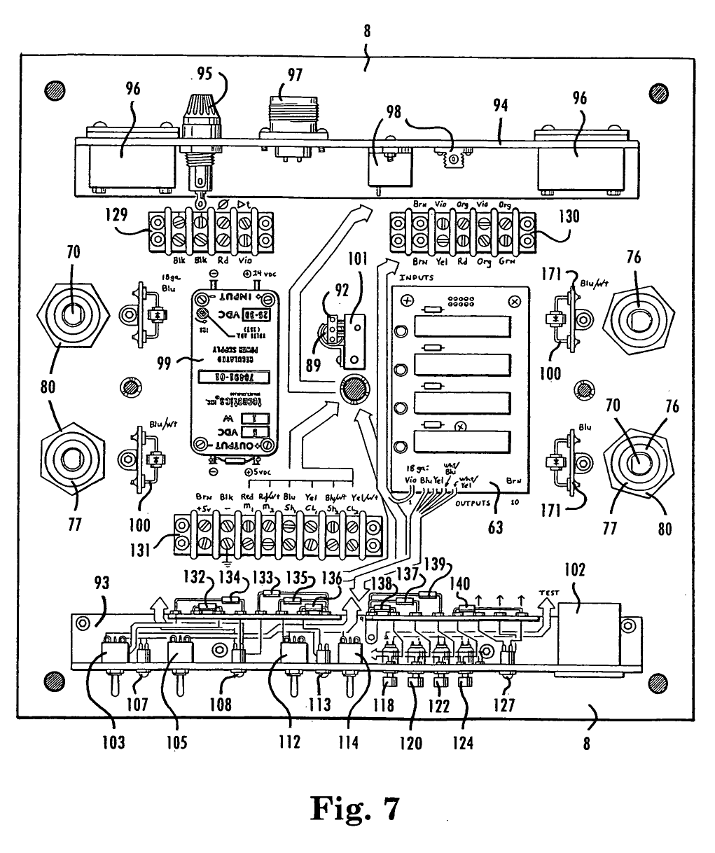

On the shifter control side, a signal from sensor 45 is amplified by transistor 48 and sent up through the umbilical cable 61 through connector 62 in FIG. 1 and through the control platform 8 and fed to the input of a solid state relay on the SSR board subassembly 63 in FIG. 7.

On the clutch control side, optical pick-up sensor 53 feeds a signal from the cam to the base of transistor 59 then up umbilical cable 61 then to an input on SSR board 63 to fire the solenoid clutches or other rod-gripping device.

Referring back to FIG. 4, on the clear cam disks 49 and 55 is either a permanent or temporary film 51 and 57 that may be moved or adjusted by turning independent of the clear cam disk 49 and 55 to control lead- or lag-time to the optical pick-up sensors 45 and 53. The film cam is held in place with holding sleeve or ring 52 and 58. In FIG. 1 when the rod-rotor 20 is in the proper position, the film cam 51 activates the optical pick-up sensor driving transistor 48 and turning on an SSR 141 that fires an electric, linear drive motor 64 powering the rack-and-pinion shifter assembly. In this invention, there are two such linear motor assemblies for each carriage mounted diagonally across from each other, but other linear motors and configurations that supply a constant shifting force along the whole amplitude of the carriage cycle can be used.

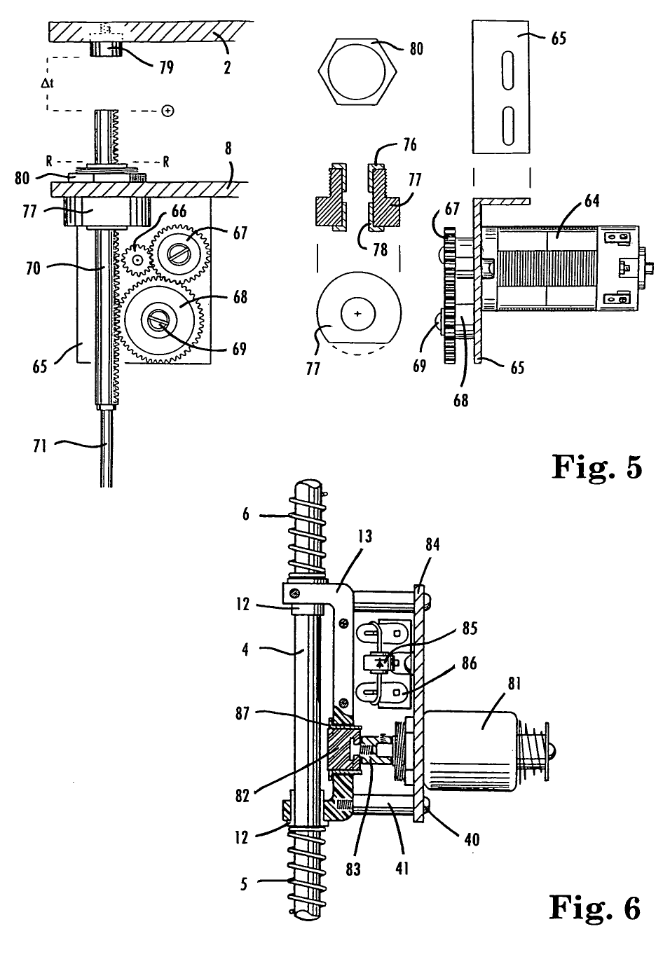

In FIG. 5, the rack-and-pinion shifter assembly comprises of linear shifter motor 64 which is mounted on motor angle plate 65 which is mounted to the control platform 8 or it can be mounted on the top cover plate 2. Said linear shifter motor's shaft holds pinion 66 that drives a series of torque increasing gears also mounted on angle plate 65. The first torque-increasing gear in direct contact with pinion 60 is idler gear 67 that drives the torque-increasing gear 68. Both these gears are mounted to angle plate 65 with shoulder screws 69. Rack driver gear 68 interfaces with a square or round rack 70 attached to linkage rod 71 which, for the bottom carriage, journals through the top carriage via bushing 72 in FIG. 1 and FIG. 3 mounted through angle bracket 73 and fastened to the top carriage tray. These linkage rods must clear the whirling rod-rotors 20 and 21 and the back of the solenoid clutch plungers. The other end of linkage rod 71 is attached to angle bracket 74 mounted on the bottom carriage tray. The top carriage tray linkage rods 71 can be directly fastened to angle brackets 75 in FIG. 1 which are mounted on the top carriage tray. The angle brackets 73, 74 and 75 are also arranged to clear the motion of the spinning rod-rotors 20 and 21 while the unit is running. Referring back to FIG. 5, the linkage rods 71 attach to the end of the rack 70 that journals through the extended rack journal subassembly 76, 77 and 78 shown in cut-a-way view and is cushioned or stopped at cycle apogee by the positive stops 79 mounted on or into the top cover plate 2. These positive stops 79 are buffers comprised of a compressible spring, rubber, vinyl, urethane or other dense resilient material to absorb the shock of intentional and unintentional impact from the racks while the system is running with shifters engaged. The extended rack journal is comprised of thermoplastic or other lightweight bushings 76 and 78 that mount into a threaded sleeve 77 which is secured through the control platform 8 with nut 80.

The rack is shown at peak positive position (+) of the normal oscillation of the carriage tray where R-R is reference mid-cycle when rotor inertia is at its lowest. At this time in the rod-rotor's cycle, the carriage tray is shifted into maximum apogee against its upper compression springs within the distance designated as At for time gained in the cycle. The control platform plate 8 is supported at a fixed distance by spacers 9 that separates it from the top plate 2 at a fixed distance determined by the total radial gain At of the system where the peak shift distance occurs within the gap between the top of rack 70 (+) and the working face of the positive stop buffer 79.

In FIG. 6, the clutch assembly consists of push-type solenoid 81 with a friction pad 82 attached to said solenoids' armature via a coupler 83 and mounted on plate 84 with spacers 41 and associated hardware (40, 42 and 43). On the other side of the carriage tray the clutch assembly is mounted directly onto the motor mount plate 29. Clutch friction pad 82 can be made of a soft, pliable material with a low-debris residual such as polyvinylchloride (PVC), or long-lasting polyurethane, or a combination of such materials. A fast recovery, reverse voltage shunting diode 85 is mounted across terminal strip 86 and electrically connected across the solenoid's coil to shunt back EMF and allow for quick release of the clutch mechanism. Another terminal strip 60 is mounted on the carriage tray assembly as shown in FIG. 4 which is in electrical parallel to the clutch solenoid and acts as a tie-off and test-point. These clutches are mounted on the corner of each carriage tray where they can engage the mainframe support rods at a precise time in the cycle to transfer centrifugal force to the mainframe for horizontal operation, in which case, the suspension springs 5 and 6 must be of equal length and the whole top control assembly has to be extended for the higher amplitude of the carriage tray's oscillations. The friction pad 82 must journal through bushing 87 to properly bind against the mainframe support rod 4 when the clutch circuit is activated by cam 57 on each carriage, depending upon the position of the rod-rotor 21.

The carriage acceleration detectors are used to fine-tune the optical cams positioning for maximum efficiency and optimal power output of the system. When videotaping the running system the duration the control panel LEDs are lit by the acceleration detectors when they make electrical contact can determine the precise timing for the rod-rotors cycle.

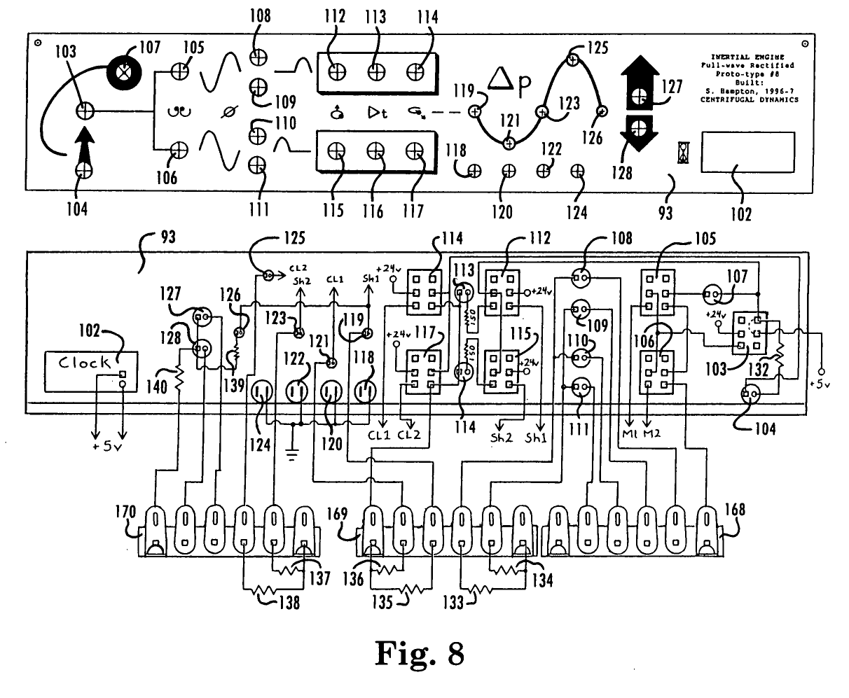

Referring back to FIG. 4, the acceleration detector consists of a microswitch 88 with its toggle balancing or holding a heavy metal slug 89 contained loosely within a sleeve 90 mounted to channel member 13 or 14 by clamp 91 with another microswitch 92 mounted above the slug with its toggle just touching the top of said slug. The sensor for upward momentum of the carriage when the rod-rotors drive it into positive phase, or when the shifters activate the carriage into apogee, is the bottom microswitch 88 and it lights indicator LED for positive acceleration on control display panel 93 in FIG. 1 and FIG. 8. When the carriage is driven downward by the rotors entering negative phase, microswitch 92 will be activated lighting indicator LED for negative acceleration on control display panel 93.

The mainframe acceleration detector functions in much the same way as the carriage acceleration detector with the exception that, in this invention, it is placed near the center on the base plate or control platform as shown in FIG. 7 to detect an overall upward momentum of the whole apparatus, but can also detect a downward momentum such as when said apparatus suddenly powers down or senses a sudden load increase. Other motion sensors may be employed to detect and display segments of the cycle period so that the invention can be finely tuned for maximum thrust.

The simplicity and versatility of the preferred invention allows for the control panel assembly 93 to mount onto either the top cover plate 2; or the control platform 8; or the said control panel assembly can also mount onto the bottom base plate 1. Likewise, the shifter assembly can be mounted on the top cover plate 2; the control platform 8; or base plate 1; the latter can hold the same shifter mechanisms which would act in a push-type fashion.

In FIG. 7, the power panel 94 holds a fuse holder or circuit breaking protection device 95 and a plurality of cooling fans 96 if needed. These and all other associated control components can be arranged on the control platform 8 to distribute the weight evenly for a balanced platform.

Also depicted in FIG. 7, are the component placements and an outline of the major circuit paths leading through the control platform via the three chamfered holes, aligned horizontally across the page, to lower parts of the engine system. Power to the rod-rotors, shifters, and clutch mechanisms is supplied through connector 97 mounted on power panel 94, which also holds and heat-sinks the overload protection circuits 98. The supply that also feeds the shifters and clutch mechanisms is fed to the input of a DC-to-DC converter 99 that provides control voltage for the logic and indicator circuits within the system. Since the shifter motors require near instantaneous response to the position of the cams, some motors may require a reverse voltage blocking, fast recovery diode 100 electrically connected in parallel across each of the shifter motors to ensure quick release of the carriages. In the present invention, solid-state relays on subassembly 63 contribute to the blocking of back EMF. An acceleration sensor identical to the one used on each carriage tray, subassembly 88 through 92 in FIG. 4, is mounted on a vertical block 101 perpendicular to, and near the center of, the surface of control platform 8. This also acts as a central support for top cover plate 2. Terminal blocks 129, 130, and 131 convey major current paths and in this invention are arranged to balance the weight of the control platform 8. Terminal block 129 is the overall power feed junction; terminal block 130 is the SSR board subassembly 63 input feed junction; and terminal block 131 is the SSR board subassembly 63 output feed junction.

In FIG. 8, the system clock 102 monitors how long the system has run since initial assembly and logs time in one-hundredths of an hour and it is mounted in the control display panel 93 which also holds the switches to control the system. Main power switch 103 illuminates LED indicator 104 when activated and also supplies power to control switch 105 for the top carriage rod-rotors and switch 106 for the bottom carriage rod-rotors. LED 107 is a flashing arming-lamp indicating when both rod-rotors are ready for simultaneous start. LED 104 flashes only when one or more clutches are on while rotors are off to warn of left-on clutches. The LED 108 illuminates when activated by the acceleration detector on the top carriage as it accelerates upward. Another LED, 109 just below 108, indicates downward acceleration of the top carriage tray assembly. Indicators LEDs 110 and 111 have the same function respectively for the bottom carriage tray assembly. Switch 112 activates the shifter circuits and LED 113 lights for the top carriage tray assembly with switch 114 controlling its clutches. Switch 115 activates the shifter circuits and LED 116 lights for the bottom carriage tray assembly with switch 117 controlling its clutches. When clutch switches 114 and/or 117 are activated without rod-rotor switches 105 or 106 activated, an alarm may sound and LED 104 flashes.

Diagnostic test switches are as follows: momentary push-button switch 118 controls the top carriage shifters with a corresponding SSR output indicator LEDs 119 and 126; momentary push-button switch 120 controls the top carriage clutches with corresponding indicator LED 121; momentary push-button switch 122 controls the bottom carriage shifters with its corresponding indicator LED 123; and momentary push-button switch 124 controls the bottom carriage clutches with its corresponding indicator LED 125. Indicator LED 127 illuminates when the mainframe acceleration detector senses an overall system gain as an upward thrust. Indicator LED 128 illuminates when the system powers down or senses a sudden load increase. With this switched LED arrangement, the system can be video taped and analyzed, thus fine-tuned for peak performance.

Referring to FIG. 7 and FIG. 8, LED current limit resistor designations are as follows: In series with LEDs 104 and 107 is resistor 132; for LEDs 108 and 110 is resistor 133; for LEDs 109 and 111 is resistor 134; for LEDs 113 and 116 the resistors are built-in the LEDs for 5-volt operation, or 150 ohms and wired directly to switches 112 and 115 respectively; for LED 119 is resistor 135; for LED 121 is resistor 136; for LED 123 is resistor 137; for LED 125 is resistor 138; for LED 126 is resistor 139; for LEDs 127 and 128 is resistor 140.

The control platform may be molded as one piece which may include items 8, 9, 65, 77, 93, 94, 101 with terminals blocks and mounting studs. Likewise, the carriages may be molded into one piece including 13, 14, 15, 16, 17, 41, 44, 46, 54, 73, 74, 75 and 84. These two major sections of the present invention may be molded from a lightweight and strong material.

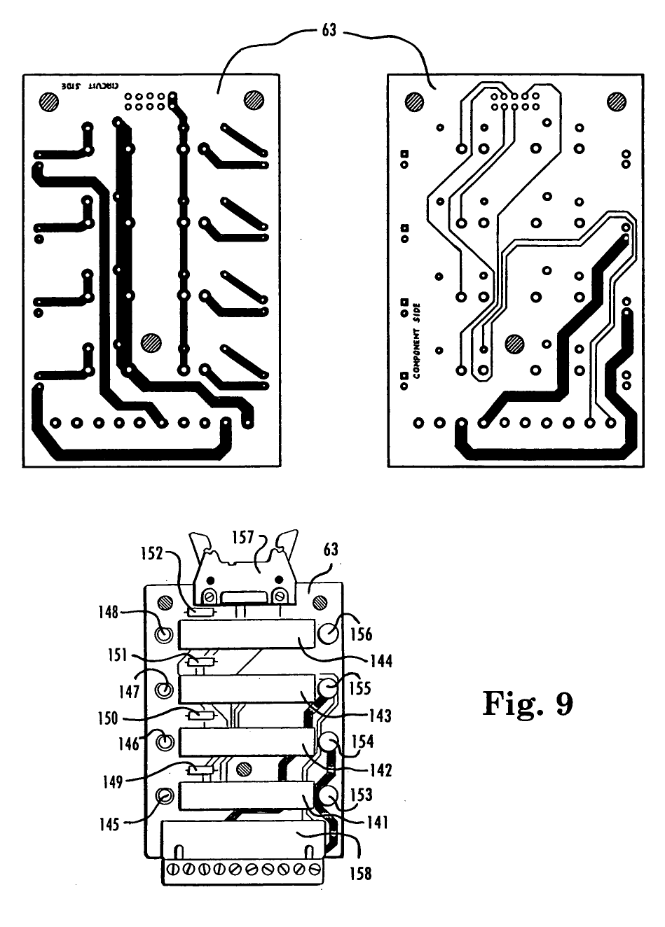

In FIG. 9 a means is provided to electronically control the shifters and clutches with an SSR printed circuit board (PCB) 63. This subassembly is designed for the present invention with printed circuitry on both broadside surfaces of said board with through-plated holes. The SSRs 141 and 143 control the shifters of the apparatus and SSRs 142 and 144 control the clutches. Each SSR also has an input indicator LED designated as 145, 146, 147, and 148 each with corresponding current limit resistor 149, 150, 151, and 152 mounted between the SSRs or beneath the PCB. The LED indicators for the outputs of the SSRs 119, 121, 123, 125, and 126 are external to the PBC and mounted on the front control panel 93. This arrangement allows easy trouble-shooting of the system. The output of each SSR is protected with fuses 153, 154, 155, and 156 respectively. Input jack 157 and output jack 158 connect the SSR board subassembly 63 to the circuitry of the invention. Other switching devices can be utilized to drive the shifters and clutches.

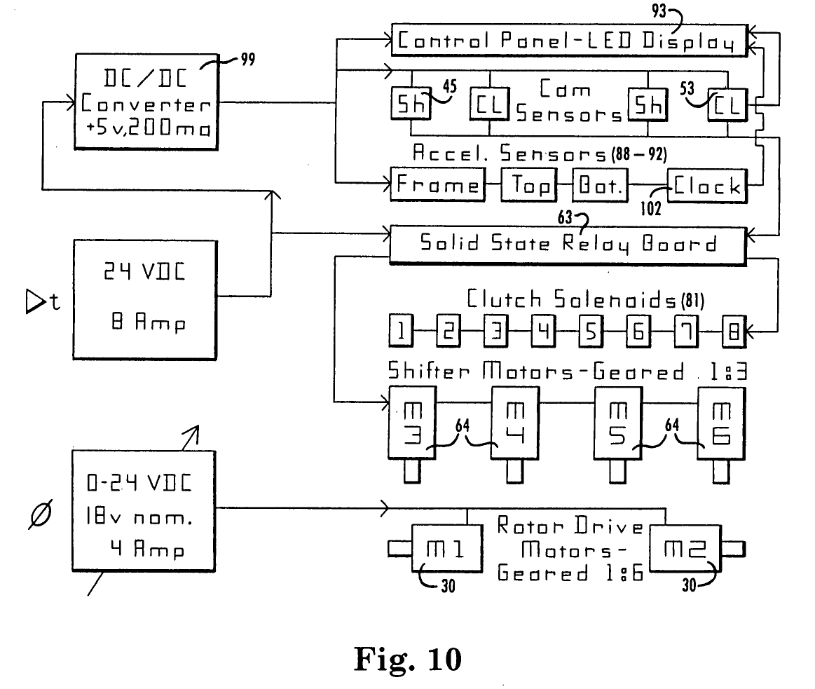

The overall electrical system for the present invention is illustrated in FIG. 10 in block diagram form, including the dual fixed-and-variable power supply providing a fixed voltage to the shifters, clutches, sensors and indicators and a variable voltage to the rod-rotors in the carriages.

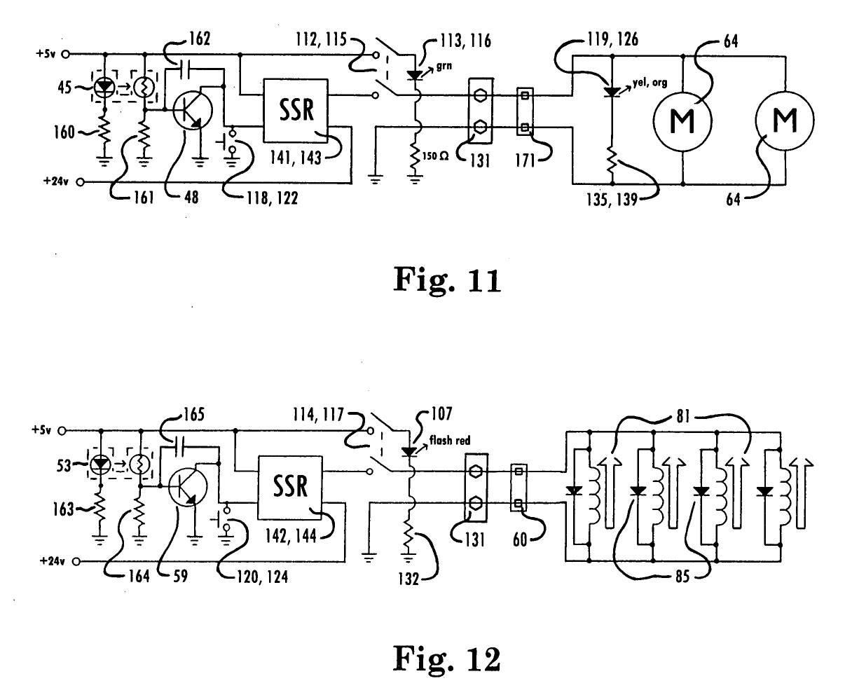

A schematic of the shifter circuit for both carriages is provided in FIG. 11 wherein resistor 160 provides current limit to the internal LED of the optical pick-up sensor 45 for the shifter motors. Also refer FIG. 4. When a change in light is detected through the optical cam 49, 51 by the pick-up sensor 45, an electrical signal is fed to the base of transistor 48 wherein the bias is set by resistor 161. The bias of said transistor is stabilized by capacitor 162 and said transistor's collector in turn feeds the input of SSR 141, 143 on subassembly 63 through terminal block 130 in FIG. 7. The output of said subassembly 63 is fed to the control display panel 93, then through terminal block 131, then through the left or right chamfered hole in control platform 8 and on to the shifter motors mounted on the underside of said control platform 8.

A schematic of the clutch circuit for both carriages is provided in FIG. 12 wherein resistor 163 provides current limit to the internal LED of the optical pick-up sensor 53 for the clutch solenoids. Again refer FIG. 4. When a change in light is detected through the optical cam 55, 57 by the pick-up sensor 53, an electrical signal is fed to the base of transistor 59 wherein the bias is set by resistor 164. The bias of said transistor is stabilized by capacitor 165 and said transistor's collector in turn feeds the input of SSR 142, 144 on subassembly 63 through terminal block 130 in FIG. 7. The output of said subassembly 63 is fed to control display panel 93, then through terminal block 131, then through the central chamfered hole in control platform 8 via connector 62 and umbilical 61 and on to the clutch solenoids on the carriages.

The preamplifier subassembly for the shifters is mounted on terminal strip 166 as depicted in FIG. 1 and FIG. 4 and the preamplifier subassembly for the clutches is mounted on terminal strip 167. The LED current limit resistors for the control display panel 93 are mounted on terminal strips 168, 169, and 170 as shown in FIG. 8. Some motors may require a reverse voltage blocking, fast recovery diode 100 connected in parallel across each of the shifter motors to ensure quick release of the carriages, in which case said diode could be mounted across terminal strip 171 which can also serve as a test point as depicted in FIG. 7.

From the foregoing, it will be apparent that the present invention provides an efficient method and self-contained apparatus for converting rotary motion into linear motion by providing unbalanced centrifugal forces which can act together in reciprocation at a rate high enough to overcome the apparatus's inertia and smoothly drive the apparatus upward against gravity or along a linear path in free space.

What I claim as my invention is:

1. Apparatus for converting rotary motion to linear motion wherein a plurality of eccentric rotors are driven within a plurality of carriage housings which are guided and journeyed by bushings furthermore suspended on compression spring-loaded support rods joined by a plurality of perpendicular plates wherein said carriages can be stacked in the same plane of oscillation.

2. Apparatus for converting rotary motion to linear motion as described in claim 1 wherein a plurality of eccentric rotors are driven within a plurality of carriage housings which are guided and journeyed by bushings furthermore suspended on compression spring-loaded support rods joined by a plurality of perpendicular plates wherein said carriages can be stacked in the same plane of oscillation
and wherein a means to restrict and control said carriages and eccentric rotors by supplying a plurality of reference and control platforms in the plane of oscillation to mount controls, indicators, and rack-and-pinion or other linear driven shifters.

3. Apparatus for converting rotary motion to linear motion as described in claim 2 wherein a plurality of eccentric rotors are driven within a plurality of carriage housings which are guided and journeyed by bushings furthermore suspended on compression spring-loaded support rods joined by a plurality of perpendicular plates wherein said carriages can be stacked in the same plane of oscillation
and wherein a means is provided to set and limit shifter stroke length with said perpendicular plates.

4. Apparatus for converting rotary motion to linear motion as described in claim 3 wherein a plurality of eccentric rotors are driven within a plurality of carriage housings which are guided and journeyed by bushings furthermore suspended on compression spring-loaded support rods joined by a plurality of perpendicular plates wherein said carriages can be stacked in the same plane of oscillation
and wherein a means is provided to join said plurality of plates perpendicular to the plane of oscillation to said compression spring-loaded support rods with support rod clamps or collars to conveniently set reference for the carriages and shifters
and to facilitate easy disassembly or assembly for repairs or transport.

5. Apparatus for converting rotary motion to linear motion as described in claim 4 wherein a plurality of eccentric rotors are driven within a plurality of carriage housings which are guided and journeyed by bushings furthermore suspended on compression spring-loaded support rods joined by a plurality of perpendicular plates wherein said carriages can be stacked in the same plane of oscillation
and wherein said compression spring-loaded support rods be supplied with shock-absorbing pads attached to one or both ends of each said compression spring-loaded support rods
and a means is supplied to mount hooks, eyebolts or other attachments on either end of said compression spring-loaded support rods to allow tethering and mounting of said apparatus.

6. Apparatus for converting rotary motion to linear motion as described in claim 5 wherein a plurality of eccentric rotors are driven within a plurality of carriage housings which are guided and journeyed by bushings furthermore suspended on compression spring-loaded support rods joined by a plurality of perpendicular plates wherein said carriages can be stacked in the same plane of oscillation
and wherein accelerations of the various parts of said apparatus can be detected with a means to display period length and direction of said accelerations within various parts of the apparatus for verification and adjustments to the carriage's period for maximum thrust.

7. Apparatus for converting rotary motion to linear motion wherein a means is provided for a compact frame or tray forming a carriage with recessed sides to house compression spring-loaded support rod journals, cams, sensors, wiring, clutches and other components with an overall minimal profile for orbiting a plurality of whirling eccentric rotors within said carriage to affect efficient shifting and clutching of said carriage by utilizing elongated axles and rotors.

8. Apparatus for converting rotary motion to linear motion as described in claim 7 wherein a means is provided for a compact frame or tray forming a carriage with recessed sides to house compression spring-loaded support rod journals, cams, sensors, wiring, clutches and other components with an overall minimal profile for orbiting a plurality of whirling eccentric rotors within said carriage to affect efficient shifting and clutching of said carriage by utilizing elongated axles and rotors
and wherein a means is provided to drive said axles and rotors with a compact torque-increasing gear train.

9. Apparatus for converting rotary motion to linear motion as described in claim 8 wherein a means is provided for a compact frame or tray forming a carriage with recessed sides to house compression spring-loaded support rod journals, cams, sensors, wiring, clutches and other components with an overall minimal profile for orbiting a plurality of whirling eccentric rotors within said carriage to affect efficient shifting and clutching of said carriage by utilizing elongated axles and rotors
and wherein a means is provided to power said compact torque-increasing gear train with a motor directly mounted on said carriage housing
and to provide a heat sink for rapid cooling of said motor fanned by the oscillation of the carriage upon where it is mounted.

10. Apparatus for converting rotary motion to linear motion as described in claim 9 wherein a means is provided for a compact frame or tray forming a carriage with recessed sides to house compression spring-loaded support rod journals, cams, sensors, wiring, clutches and other components with an overall minimal profile for orbiting a plurality of whirling eccentric rotors within said carriage to affect efficient shifting and clutching of said carriage by utilizing elongated axles and rotors
and to power the eccentric rotors with encoder, stepper, or servo motors that have the required torque to drive said rotors to allow shifting and clutching of said carriages only when said carriages are in proper position to ensure the smooth generation of thrust.

11. Apparatus for converting rotary motion to linear motion as described in claim 10 wherein a means is provided for a compact frame or tray forming a carriage with recessed sides to house compression spring-loaded support rod journals, cams, sensors, wiring, clutches and other components with an overall minimal profile for orbiting a plurality of whirling eccentric rotors within said carriage to affect efficient shifting and clutching of said carriage by utilizing elongated axles and rotors
and wherein a means is provided to brake said carriage housing against the compression spring-loaded support rods with a plurality of clutches mounted directly on said carriage.

12. Apparatus for converting rotary motion to linear motion as described in claim 11 wherein a means is provided for a compact frame or tray forming a carriage with recessed sides to house compression spring-loaded support rod journals, cams, sensors, wiring, clutches and other components with an overall minimal profile for orbiting a plurality of whirling eccentric rotors within said carriage to affect efficient shifting and clutching of said carriage by utilizing elongated axles and rotors
and to provide a means to actuate and affect a quick release of said clutches with a cam directly or indirectly driven by said whirling eccentric rotors or its axles at a predetermined position of said whirling eccentric rotors.

13. Apparatus for converting rotary motion to linear motion wherein a plurality of carriages are shifted by rack-and-pinion or other linear motors connected by linkage rods journeyed through and to said carriages just beyond the orbit of the whirling eccentric rotors, clutch armatures and other components to affect compact and efficient shifting of said carriages providing a constant and even force throughout the complete amplitude of each carriage cycle.

14. Apparatus for converting rotary motion to linear motion as described in claim 13 wherein a plurality of carriages are shifted by rack-and-pinion or other linear motors connected by linkage rods journeyed through and to said carriages just beyond the orbit of the whirling eccentric rotors, clutch armatures and other components to affect compact and efficient shifting of said carriages providing a constant and even force throughout the complete amplitude of each carriage cycle
and provide support for the rack- or linear-shifter with extended journals.

15. Apparatus for converting rotary motion to linear motion as described in claim 14 wherein a plurality of carriages are shifted by rack-and-pinion or other linear motors connected by linkage rods journeyed through and to said carriages just beyond the orbit of the whirling eccentric rotors, clutch armatures and other components to affect compact and efficient shifting of said carriages providing a constant and even force throughout the complete amplitude of each carriage cycle
and wherein a means is provided to actuate the shifters and clutches utilizing electronic cams directly or indirectly driven by said whirling eccentric rotors or its axles at a predetermined position of said eccentric rotors.

16. Apparatus for converting rotary motion to linear motion as described in claim 15 wherein a plurality of carriages are shifted by rack-and-pinion or other linear motors connected by linkage rods journeyed through and to said carriages just beyond the orbit of the whirling eccentric rotors, clutch armatures and other components to affect compact and efficient shifting of said carriages providing a constant and even force throughout the complete amplitude of each carriage cycle
and wherein a means is provided to actuate with electronic or mechanical cams the shifters and clutches utilizing electronic switches or relays mounted directly on a lightweight and compact circuit board.

17. Apparatus for converting rotary motion to linear motion as described in claim 16 wherein a plurality of carriages are shifted by rack-and-pinion or other linear motors connected by linkage rods journeyed through and to said carriages just beyond the orbit of the whirling eccentric rotors, clutch armatures and other components to affect compact and efficient shifting of said carriages providing a constant and even force throughout the complete amplitude of each carriage cycle
and supply a means to display period lengths of said shifters and clutches to determine the proper adjustments for maximum performance.

18. Apparatus for converting rotary motion to linear motion as described in claim 17 wherein a plurality of carriages are shifted by rack-and-pinion or other linear motors connected by linkage rods journeyed through and to said carriages just beyond the orbit of the whirling eccentric rotors, clutch armatures and other components to affect compact and efficient shifting of said carriages providing a constant and even force throughout the complete amplitude of each carriage cycle
and wherein the two or more carriages are controlled in such a manner as to reciprocate equally or in proper sequence by means of a plurality of motion sensitive switches connected electrically or mechanically to said carriages, rotors, axles, shifters or clutches to ensure the smooth generation of thrust.
